(19) United States
(12) Patent Application Publication
(10) Pub. No.: US 2014/0076922 A1
(43) Pub. Date: Mar. 20, 2014

(54) Product Dispensing System with Increased Container and Dispenser Openings

(71) Applicant: MEADWESTVACO CORPORATION, Richmond, VA (US)

(72) Inventors: Ron Binshtok, Richmond, VA (US); William J. Bogdziewicz, III, Richmond, VA (US); Steven Burton, Richmond, VA (US)

(73) Assignee: MeadWestvaco Corporation, Richmond, VA (US)

(21) Appl. No.: 13/623,268

(22) Filed: Sep. 20, 2012

(51) Int. Cl. B65G 59/00

(52) U.S. Cl. 221/285

(57) ABSTRACT

A product dispensing system including a dispenser frame having a front end longitudinally opposed from a rear end, the frame including an upper support deck extending between the front and rear ends, the upper support deck defining a dispenser opening having a first longitudinal length, and a lower support deck positioned below the upper support deck, the lower support deck defining a product display area, a container positioned on the upper support deck, wherein the container defines a container opening having a second longitudinal length, the container opening being aligned with the dispenser opening, and a plurality of products initially housed in the container, wherein the products are configured to roll about a rolling axis and have a greatest transverse dimension perpendicular to the rolling axis, wherein the first and second longitudinal lengths are substantially greater than the greatest transverse dimension.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing twelve individual cans. Then, it is typically the retailer's obligation to remove the individual product units from the container and present them to consumers.

Alternatives to the traditional package-ship-unpack-display model are being developed in an effort to improve operating efficiency. One system for dispensing and displaying products initially packaged in a container is disclosed in U.S. Pat. No. 7,922,437 to Loftin et al. The Loftin system includes a dispenser having a frame and an opening tool. The dispenser may be positioned on a retailer's shelf and loaded with product simply by placing a container comprising multiple units of product onto the frame of the dispenser. As the container is being placed onto the frame, the opening tool of the dispenser opens the container in such a manner that products move from the container and down to a product display area of the frame under the force of gravity.

Another system for dispensing and displaying products initially packaged in a container is disclosed in U.S. patent application Ser. No. 13/032,734 filed by Gelardi et al. The Gelardi system utilizes an opening tool having a catch element that engages and opens a container as the container is loaded onto the dispenser, and then guides the container to avoid interference between the dispensing products and the open container.

Despite advances already made in the field, those skilled in the art continue with research and development efforts directed to apparatus and systems for dispensing products from packaging containers.

### SUMMARY

In one embodiment, the disclosed product dispensing system may include a dispenser frame having a front end longitudinally opposed from a rear end, the frame including an upper support deck extending between the front and rear ends, the upper support deck defining a dispenser opening having a first longitudinal length, and a lower support deck positioned below the upper support deck, the lower support deck defining a product display area, a container positioned on the upper support deck, wherein the container defines a container opening having a second longitudinal length, the container opening being aligned with the dispenser opening, and a plurality of products initially housed in the container, wherein the products are configured to roll about a rolling axis and have a greatest transverse dimension perpendicular to the rolling axis, wherein the first and second longitudinal lengths are substantially greater than the greatest transverse dimension.

In another embodiment, the disclosed product dispensing system may include a dispenser frame having a front end longitudinally opposed from a rear end, the frame including an upper support deck extending between the front and rear ends, the upper support deck defining a dispenser opening having a first longitudinal length, and a lower support deck positioned below the upper support deck, the lower support deck defining a product display area proximate the front end, a container positioned on the upper support deck, wherein the container defines a container opening having a second longitudinal length, the container opening being aligned with the dispenser opening, and a plurality of products initially housed in the container, wherein the products are configured to roll about a rolling axis and have a greatest diameter perpendicular to the rolling axis, wherein the first and second longitudinal lengths are at least 1.5 times the greatest diameter.

In yet another embodiment, the disclosed product dispensing system may include a dispenser frame having a front end longitudinally opposed from a rear end, the frame including an upper support deck extending between the front and rear ends, the upper support deck defining a dispenser opening having a first longitudinal length, and a lower support deck positioned below the upper support deck, the lower support deck defining a product display area proximate the front end, a container positioned on the upper support deck, wherein the container defines a container opening having a second longitudinal length, the container opening being aligned with the dispenser opening, and a plurality of products initially housed in the container, wherein the products are configured to roll about a rolling axis and have a greatest diameter perpendicular to the rolling axis, wherein the first longitudinal length is sufficient to allow at least two products to simultaneous pass through the dispenser opening, and wherein the second longitudinal length is sufficient to allow at least two products to simultaneous pass through the container opening.

Other embodiments of the disclosed product dispensing system with increased container and dispenser openings will become apparent from the following detailed description, the accompanying drawings and the appended claims.

### BRIEF DESCRIPTION OF THE DRAWINGS

FIG. 1 is a front and side perspective view of one embodiment of the disclosed product dispensing system with increased container and dispenser openings;

FIG. 2 is a bottom and side perspective view of the container of the product dispensing system of FIG. 1;

FIG. 3 is a side elevational view of the container of FIG. 2;

FIG. 4 is a bottom and side perspective view of the container of FIG. 2 shown in an opened configuration;

FIG. 5 is a bottom plan view of the container of FIG. 4;

FIG. 6 is a side elevational view, in section, of the dispenser of the product dispensing system of FIG. 1;

FIG. 7 is a side elevational view, in section, of the dispenser of FIG. 6 shown with the container of FIG. 3 in a first, partially loaded configuration;

FIG. 8 is a side elevational view, in section, of the product dispensing system of FIG. 7 in a second, fully loaded configuration; and

FIG. 9 is a side elevational view, in section, of the product dispensing system of FIG. 8 in a third, fully dispensed configuration.

### DETAILED DESCRIPTION

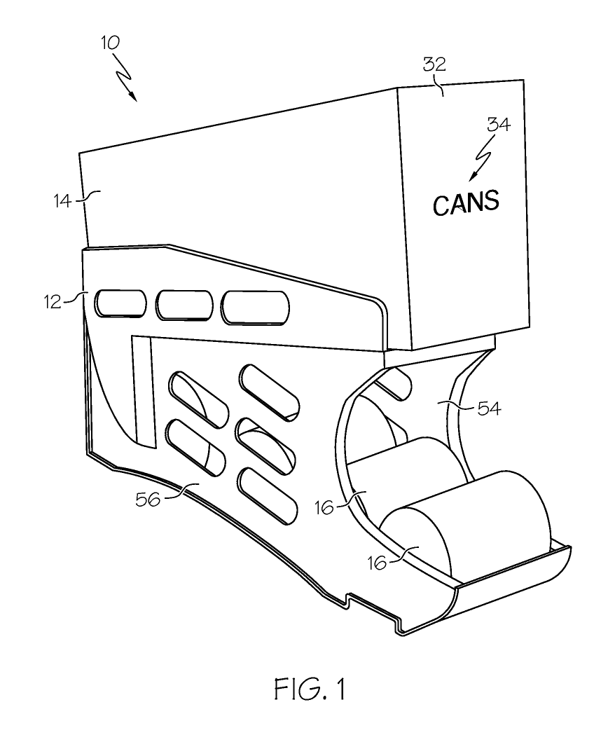

Referring to FIG. 1, one embodiment of the disclosed product dispensing system with increased container and dispenser openings, generally designated 10, may include a dispenser 12 and a container 14. The container 14 may initially house multiple units of product 16. The container 14 may be loaded onto the dispenser 12 such that the products 16 within the container 14 are released (at least partially) to the dispenser 12.

The container 14 may be any container capable of housing products 16 and beneficially interacting with the disclosed dispenser 12. For example, the container 14 may be a paperboard carton or a corrugated box. While a generally rectilinear container 14 is described below, containers having other shapes and configurations may be used without departing from the scope of this disclosure.

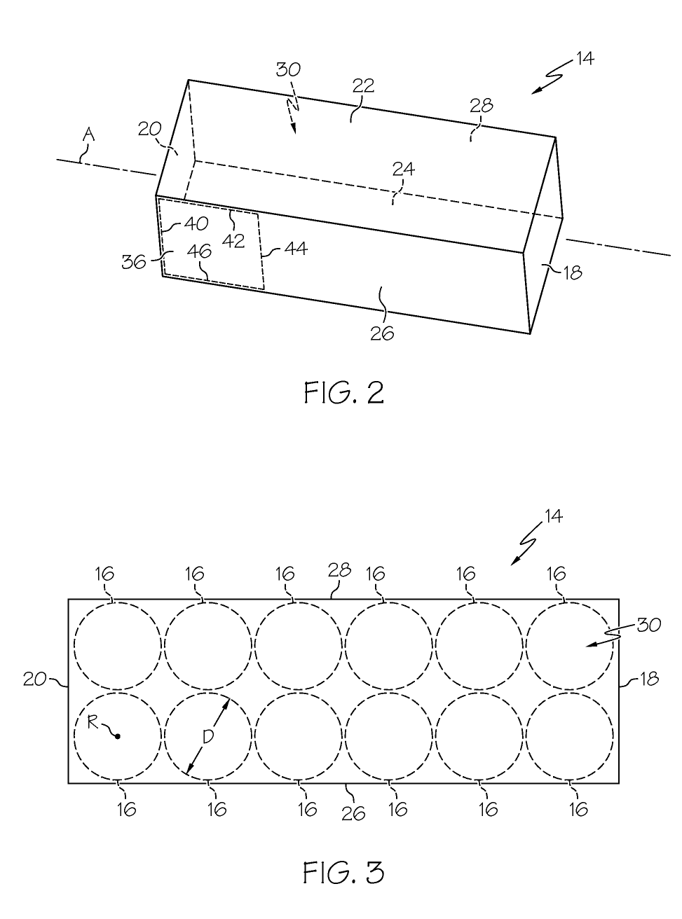

Referring to FIGS. 2 and 3, the container 14 may be a generally rectilinear container having a longitudinal axis A (FIG. 2). The container 14 may be elongated along the longitudinal axis A, and may include six walls 18, 20, 22, 24, 26, 28 that define an internal volume 30 for receiving the products 16. Opposed walls 18 and 20 may define the front and rear walls, respectively, of the container 14. Opposed walls 22 and 24 may define the first (e.g., left) and second (e.g., right) side walls, respectively, of the container 14. Opposed walls 26 and 28 may define the base and upper walls, respectively, of the container 14.

The container 14 may be assembled on a container machine or the like using a container blank that has been pre-cut from a sheet of stock material. As one example, the stock material may be a paperboard-based material, such as C1S paperboard, which may have a coating (e.g., clay) on a first major surface thereof, which may form the outer surface 32 (FIG. 1) of the container 14, and an uncoated second major surface. As another example, the stock material may be C2S paperboard, which may have a coating (e.g., clay) on both major surfaces thereof. Optionally, the outer surface 32 of the container 14 may be marked with various indicia 34 (FIG. 1), such as advertising text and/or graphics.

Various products 16 having various shapes and configurations may be housed in the container 14 and dispensed by the disclosed product dispensing system 10. Non-limiting examples of suitable products 16 include cans (e.g., canned soup or pet food), jars (e.g., jarred sauce) or bottles (e.g., bottled soft drinks)

Referring to FIGS. 3 and 5, the products 16 may be initially housed in the internal volume 30 of the container 14. For example, the products 16 may be arranged in one or more rows, such as two stacked rows, within the container 14. The products 16 may be capable of rolling about a rolling axis R, and may have a greatest transverse dimension D, such as a greatest diameter, perpendicular to the rolling axis R.

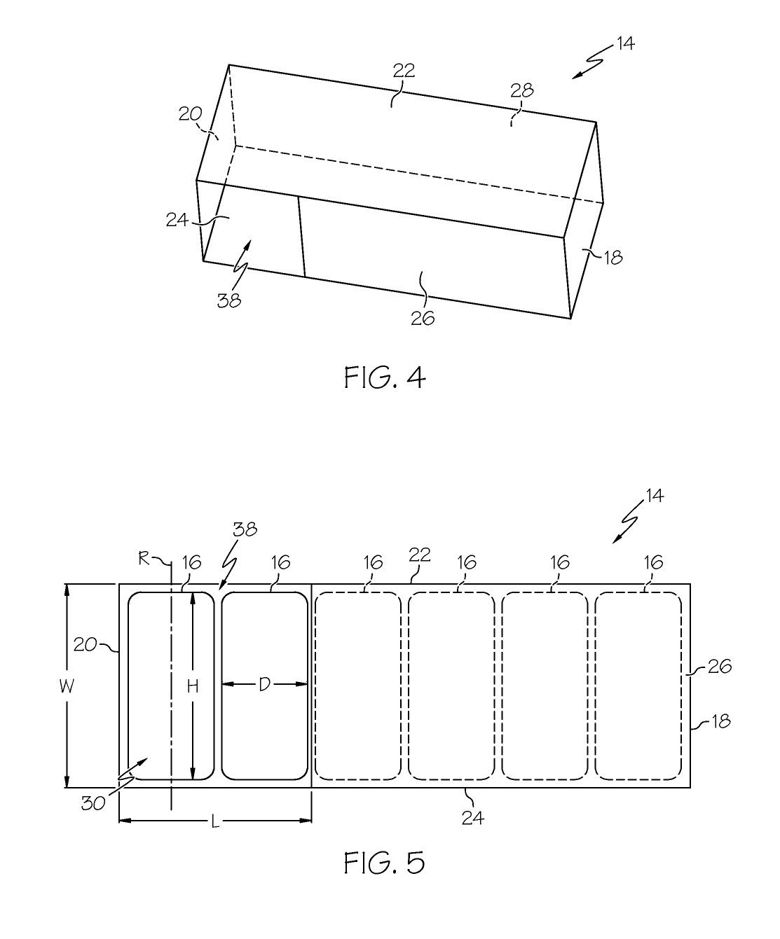

In one aspect, the container 14 may define a pre-formed container opening 38 (see FIGS. 4 and 5) into the internal volume 30 of the container 14. For example, the pre-formed container opening 38 may be formed in the base wall 26 proximate (i.e., at or near) the rear wall 20. Therefore, use of a pre-formed opening 38 may avoid the need for opening the container 14 during (or prior to) loading of the container 14 onto the dispenser 12.

Optionally, the pre-formed container opening 38 may be initially covered by a peelable label (not shown) or the like. Therefore, the peelable label may be removed to reveal the pre-formed opening 38 prior to loading the container 14 onto the dispenser 10 (FIG. 1).

In another aspect, the container 14 may include an access panel 36, as shown in FIG. 2. As shown in FIGS. 4 and 5, the access panel 36 may be at least partially separated (if not fully removed, as shown in FIGS. 4 and 5) from the container 14 to reveal the container opening 38 into the internal volume 30 of the container 14.

Referring to FIG. 2, the access panel 36 may be formed in the base wall 26 of the container 14 proximate the rear wall 20 of the container 14. However, those skilled in the art will appreciate that the specific location of the access panel 36 on the container 14 may be dictated by the desired location of the container opening 38.

The access panel 36 may be defined by one or more weakening features 40, 42, 44, 46. For example, weakening feature 40 may laterally extend between the side walls 22, 24 proximate the rear wall 20; weakening feature 44 may laterally extend between the side walls 22, 24 and may be longitudinally spaced from weakening feature 40; weakening feature 42 may longitudinally extend proximate side wall 22 between weakening features 40, 44; and weakening feature 46 may longitudinally extend proximate side wall 24 between weakening features 40, 44.

The weakening features 40, 42, 44, 46 may facilitate the separation of the access panel 36 from the container 14 to reveal the container opening 38 (FIG. 4). In one variation, the weakening features 40, 42, 44, 46 may be perforations. For example, the weakening features 40, 42, 44, 46 may be formed as rows of standard perforations, as rows of micro perforations or as rows of zipper-like cuts. In another variation, the weakening features 40, 42, 44, 46 may be formed by scoring the container 14. In yet another variation, the weakening features 40, 42, 44, 46 may be formed by creasing the container 14. Other techniques for forming the weakening features 40, 42, 44, 46 are also contemplated.

Thus, the container opening 38 may be pre-formed in the container 14 or may be formed in the container 14 by separating an access panel 36 from the container 14 along one or more weakening features 40, 42, 44, 46. As described in greater detail below, the step of separating the access panel 36 from the container 14 may be performed manually (e.g., prior to loading the container 14 onto the dispenser 12) or automatically (e.g., by an opening tool (discussed below) during loading of the container 14 onto the dispenser 12).

Referring to FIGS. 4 and 5, the container opening 38 may be formed in the base wall 26 of the container 14 proximate the rear wall 20. The container opening 38 may extend generally laterally between the side walls 22, 24 of the container 14 and may extend generally longitudinally between the front and rear walls 18, 20. Therefore, the container opening 38 may have a lateral width W and a longitudinal length L, as shown in FIG. 5.

The lateral width W of the container opening 38 may be of a sufficient magnitude to allow products 16 to pass through the container opening 38. For example, the lateral width W of the container opening 38 may greater than the overall height H (along the rolling axis R) of the products 16.

The longitudinal length L of the container opening 38 may be substantially greater than the greatest transverse dimension D (e.g., diameter) of a product 16. In one expression, the longitudinal length L of the container opening 38 may be at least 1.5 times the greatest transverse dimension D of a product 16. In another expression, the longitudinal length L of the container opening 38 may be at least 1.6 times the greatest transverse dimension D of a product 16. In another expression, the longitudinal length L of the container opening 38 may be at least 1.7 times the greatest transverse dimension D of a product 16. In another expression, the longitudinal length L of the container opening 38 may be at least 1.8 times the greatest transverse dimension D of a product 16. In another expression, the longitudinal length L of the container opening 38 may be at least 1.9 times the greatest transverse dimension D of a product 16. In another expression, the longitudinal length L of the container opening 38 may be at least 2 times the greatest transverse dimension D of a product 16. In another expression, the longitudinal length L of the container opening 38 may be at least 2.1 times the greatest transverse dimension D of a product 16. In another expression, the longitudinal length L of the container opening 38 may be at least 2.2 times the greatest transverse dimension D of a product 16. In another expression, the longitudinal length L of the container opening 38 may be at least 2.3 times the greatest transverse dimension D of a product 16. In another expression, the longitudinal length L of the container opening 38 may be at least 2.4 times the greatest transverse dimension D of a product 16. In yet another expression, the longitudinal length L of the container opening 38 may be at least 2.5 times the greatest transverse dimension D of a product 16.

Thus, the substantial longitudinal length L of the container opening 38 may encourage products 16 to more readily exit the container 14 through the container opening 38, thereby avoiding product bridging within the container 14. Product bridging is described in greater detail in U.S. patent application Ser. No. 13/426,811 filed on Mar. 22, 2012, the entire contents of which are incorporated herein by reference. Indeed, by sufficiently increasing the longitudinal length L of the container opening 38, two or more products 16 may simultaneously exit the container 14 through the container opening 38.

At this point, those skilled in the art will appreciate that the longitudinal length L required to allow two products 16 to simultaneously exit the container 14 may depend on factors other than the greatest transverse dimension D of the products 16, such as the shape and contour of the products 16. For example, when adjacent products 16 in the container 14 are nesting, the longitudinal length L required to allow two products 16 to simultaneously exit the container 14 may be less than two times the greatest transverse dimension D of the products 16.

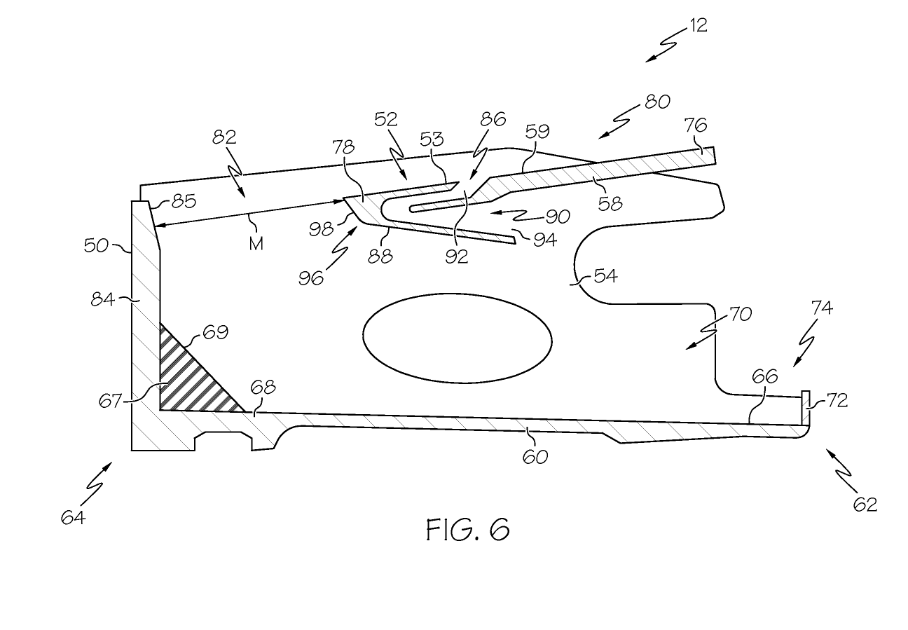

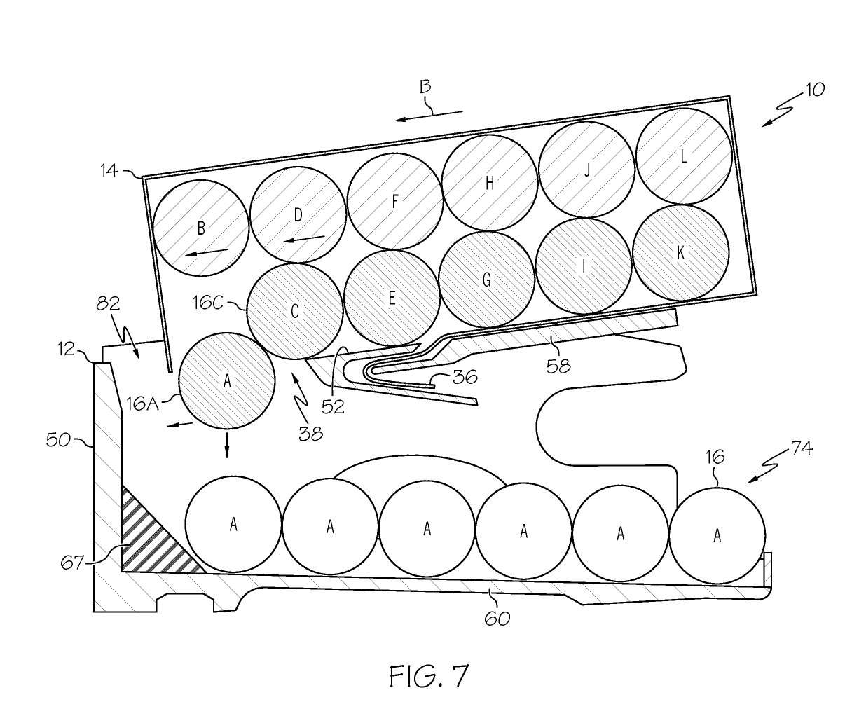

Referring to FIG. 6, the dispenser 12 may include a dispenser frame 50 that supports the container 14 in a desired configuration, such as a slightly declined, but generally horizontal configuration, as shown in FIG. 1. The container 14 may be positioned on the frame 50 of the dispenser 12 to allow products 16 to dispense from the container 14 (by way of the container opening 38) to the dispenser 12.

The frame 50 may include a first (e.g., right) side wall 54, a second (e.g., left) side wall 56 (FIG. 1), an upper support deck 58 and a lower support deck 60. The right side wall 54 may be laterally spaced from the left side wall 56, and may be generally parallel with the left side wall 56. The frame 50 may include a first (front) end 62 and a second (rear) end 64 longitudinally opposed from the front end 62.

The lower support deck 60 may laterally extend between the right and left side walls 54, 56, and may include a front end 66 that longitudinally extends toward the front end 62 of the frame 50 and a rear end 68 that longitudinally extends toward the rear end 64 of the frame 50. Therefore, the lower support deck 60 and the side walls 54, 56 may define a lower level 70 of the frame 50.

The lower support deck 60 may be inclined from the front end 66 to the rear end 68 (i.e., the rear end 68 may be elevated relative to the front end 66) such that products 16 deposited proximate the rear end 68 of the lower support deck 60 roll (about rolling axis R shown in FIG. 5) down to the front end 66 of the lower support deck 60 under the force of gravity. The extent of the incline of the lower support deck 60 may be dictated by, among other things, the coefficient of friction of the material used to form the frame 50 and the shape of the products 16 to be dispensed by the dispenser 12, among other factors.

A stop 72 may be positioned proximate the front end 66 of the lower support deck 60 to prevent products 16 from rolling beyond the front end 66 of the lower support deck 60. For example, the stop 72 may be connected to (e.g., integral with) the lower support deck 60, and may form an abrupt stop or an upward curve (not shown) at the front end 66 of the lower support deck 60. Therefore, the stop 72 may collect products 16 at the front end 66 of the lower support deck 60, thereby defining a product display area 74 at the front end 66 of the lower support deck 60.

An obstruction 67 may be positioned proximate the rear end 68 of the lower support deck 60. In one variation, the obstruction 67 may simply function as a stop that prevents products 16 on the lower support deck 60 from moving rearward beyond the obstruction 67. Therefore, the obstruction 67 may urge products 16 toward the front end 66 of the lower support deck 60, and may prevent products 16 from moving rearward to a position that supports product bridging (i.e., the arrangement of products 16 that results in a blockage). In another variation, the obstruction 67 may include an angled surface 69. The angled surface 69 of the obstruction 67 may function as a guide that more gradually transitions products 16 down to the lower support deck 60, while still preventing products 16 from moving rearward to a position that supports product bridging.

The upper support deck 58 may laterally extend between the right and left side walls 54, 56, and may include a front end 76 that longitudinally extends toward the front end 62 of the frame 50 and a rear end 78 that longitudinally extends toward, but not to, the rear end 64 of the frame 50. Therefore, the upper support deck 58 and the side walls 54, 56 may define an upper level 80 of the frame 50.

The spacing between the rear end 78 of the upper support deck 58 and the rear end 64 of the frame 50 (e.g., rear wall 84 of the frame 50) may define a dispenser opening 82. The dispenser opening 82 may function as a chute to allow products 16 to drop (under the force of gravity) from the upper level 80, through the dispenser opening 82, and down to the lower level 70 of the frame 50.

The dispenser opening 82 may have a longitudinal length M. Like the container opening 38, the dispenser opening 82 may be substantially greater than the greatest transverse dimension D (e.g., diameter) of a product 16. In one expression, the longitudinal length M of the dispenser opening 82 may be at least 1.5 times the greatest transverse dimension D of a product 16. In another expression, the longitudinal length M of the dispenser opening 82 may be at least 1.6 times the greatest transverse dimension D of a product 16. In another expression, the longitudinal length M of the dispenser opening 82 may be at least 1.7 times the greatest transverse dimension D of a product 16. In another expression, the longitudinal length M of the dispenser opening 82 may be at least 1.8 times the greatest transverse dimension D of a product 16. In another expression, the longitudinal length M of the dispenser opening 82 may be at least 1.9 times the greatest transverse dimension D of a product 16. In another expression, the longitudinal length M of the dispenser opening 82 may be at least 2 times the greatest transverse dimension D of a product 16. In another expression, the longitudinal length M of the dispenser opening 82 may be at least 2.1 times the greatest transverse dimension D of a product 16. In another expression, the longitudinal length M of the dispenser opening 82 may be at least 2.2 times the greatest transverse dimension D of a product 16. In another expression, the longitudinal length M of the dispenser opening 82 may be at least 2.3 times the greatest transverse dimension D of a product 16. In another expression, the longitudinal length M of the dispenser opening 82 may be at least 2.4 times the greatest transverse dimension D of a product 16. In yet another expression, the longitudinal length M of the dispenser opening 82 may be at least 2.5 times the greatest transverse dimension D of a product 16.

Thus, the substantial longitudinal length M of the dispenser opening 82 may facilitate the movement of products 16 from the container 14 (by way of the container opening 38) down to the lower level 70 of the frame 50. Indeed, by sufficiently increasing the longitudinal length M of the dispenser opening 38, two or more products 16 may simultaneously drop (under the force of gravity) from the upper level 80, through the dispenser opening 82, and down to the lower level 70 of the frame 50.

The upper support deck 58 may be declined from the front end 76 to the rear end 78 (i.e., the front end 76 may be elevated relative to the rear end 78). Therefore, under the force of gravity, products 16 supported on the upper support deck 58 may roll down to the rear end 78 of the upper support deck 58, may pass through the dispenser opening 82 down to the lower level 70 of the frame 50 and, ultimately, may move to the product display area 74.

A rear wall 84 may be positioned at the rear end 64 of the frame 50 between the right and left side walls 54, 56. The rear wall 84 may serve as (or may include) a rear stop 85 that inhibits rearward horizontal movement of the container 14 (FIG. 1) along the upper support deck 58 beyond the rear wall 84.

Prior to dispensing products by way of the dispenser 12, the container opening 38 (FIGS. 4 and 5) may be formed in the container 14. As noted above, the container opening 38 may be pre-formed in the container 14 and, therefore, no opening step may be required (other than removing the optional peelable label). If the container 14 includes the access panel 36 (FIG. 2), then the access panel 36 may be separated from the container 14 to form the container opening 38. While the access panel 36 may be manually separated, an optional opening tool 52 may be associated with the dispenser 12 to effect automatic separation of the access panel 36 (and corresponding formation of the container opening 38) upon loading the container 14 onto the dispenser 12.

Still referring to FIG. 6, in one construction, the opening tool 52 may include a catch element 53, as disclosed in greater detail in U.S. patent application Ser. No. 13/032,734 filed on Feb. 23, 2011 by Gelardi et al., the entire contents of which are incorporated herein by reference.

The opening tool 52 may be connected to the upper support deck 58 proximate the rear end 78 of the upper support deck 58. The catch element 53 of the opening tool 52 may laterally extend between the side walls 54, 56 of the frame 50, and may longitudinally protrude toward the front end 62 of the frame 50.

In an effort to minimize interference between the opening tool 52 and the container 14 during loading, the catch element 53 of the opening tool 52 may be substantially co-planar with the upper surface 59 of the upper support deck 58. However, those skilled in the art will appreciate that slight displacement and/or a slight angle of the catch element 53 of the opening tool 52 relative to the upper surface 59 of the upper support deck 58 may encourage engagement of the access panel 36 (FIG. 2) of the container 14 by the catch element 53 of the opening tool 52.

While the catch element 53 of the opening tool 52 is shown and described as a generally flat, laterally elongated protrusion, those skilled in the art will appreciate that various alternative structures may be used without departing from the scope of the present disclosure. For example, suitable catch elements 53 may include various hooks, protrusions, flanges, detents and the like sufficient to engage the access panel 36 (FIG. 2) in the container 14 and separate the access panel 36 from the base wall 26 of the container 14.

The upper support deck 58 may define an opening 86 proximate the forward-most end of the catch element 83 of the opening tool 82. The opening 86 may extend below the catch element 83, and may have a lateral width sufficient to allow the access panel 36 (FIG. 2) to pass therethrough.

A panel guide assembly 88 may be connected to the upper support deck 58 below the opening 86. The panel guide assembly 88 may define a U-shaped channel 90 having a first end 92 and a second end 94. The first end 92 of the channel 90 may be coupled with the opening 86 in the upper support deck 58. The second end 94 of the channel 90 may open toward the front end 62 of the frame 50.

Thus, the catch element 53 of the opening tool 52 may engage the access panel 36 (FIG. 2) in the container 14 and may separate the access panel 52 (FIG. 3) from the container 14 as the container 14 is moved longitudinally (e.g., generally horizontally) along the upper support deck 58 toward the rear end 64 of the frame 50. As the container 14 moves relative to the opening tool 52, the opening tool 52 may urge the separated access panel 36 downward through the opening 86 and into the panel guide assembly 88, thereby forming the container opening 38 (FIG. 4) in the container 14.

Optionally, the panel guide assembly 88 may include a rear end 96 having an angled surface 98. The angled surface 98 of the panel guide assembly 88 may be angled downward and toward the front end 62 of the frame 50. Therefore, any products 16 coming into contact with the rear end 96 of the panel guide assembly 88 may be directed downward (i.e., toward the lower support deck 60) and toward the front end 62 of the frame (i.e., toward the product display area 74).

In another construction, the opening tool 52 may include one or more cutting blade (not shown), as disclosed in greater detail in U.S. Pat. No. 7,922,437 to Loftin et al., which issued on Apr. 12, 2011, the entire contents of which are incorporated herein by reference. Other opening tools 52 for automatically forming the container opening 38 (FIG. 4) in the container 14 are also contemplated.

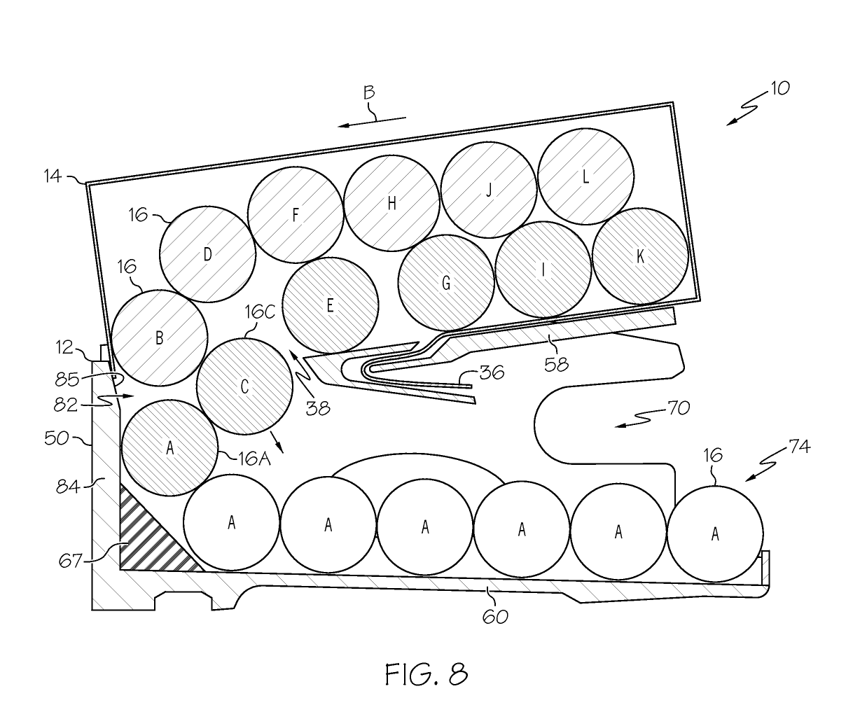

FIGS. 7-9 illustrate loading of the container 14 onto the dispenser 12 to effect dispensing of the products 16 from the container 14 to the product display area 74 of the dispenser 12.

Referring to FIG. 7, the container 14 may be longitudinally urged along the upper support deck 58 in the direction shown by arrow B. The opening tool 52 may engage the container 14 and may begin to separate the access panel 36 from the container 14. The separated access panel 36 may be directed downward through the opening 86 (FIG. 6) in the upper support deck 58 and into the panel guide assembly 88, thereby partially forming the container opening 38 in the container 14.

Referring to FIG. 8, once the container 14 reaches the fully loaded configuration (e.g., the container 14 is in abutting engagement with the rear stop 85), the container opening 38 may be fully formed and aligned with the dispenser opening 82. Therefore, the first two products 16A, 16C initially housed in the container 14 may together (rather than purely sequentially) exit the container opening 38, may together pass through the dispenser opening 82, and may move down to the lower level 70 of the frame 50. Subsequent products 16 may follow the first two products 16A, 16C.

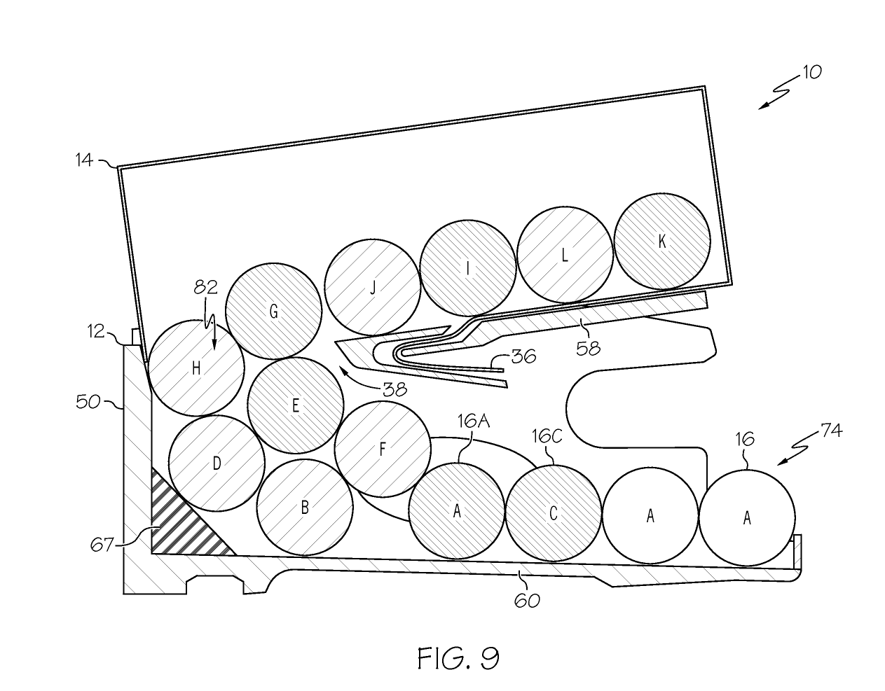

Referring to FIG. 9, as products 16 are removed from the dispenser 12 by way of the product display area 74, gravity may continue to feed products 16 from the container 14, through the container and dispenser openings 38, 82, down to the lower level 70 of the frame 50 and, ultimately, to the product display area 74.

By substantially increasing the longitudinal length L (FIG. 5) of the container opening 38 and the longitudinal length M (FIG. 6) of the dispenser opening 82, products 16 may more readily exit the container 14 through the container opening 38 and pass through the dispenser opening 82. Therefore, by avoiding a purely sequential one-by-one passing of products 16 from the container 14 to the dispenser 12, the occurrence of product bridging (blockage) within the container 14 and the dispenser 12 may be significantly reduced (if not eliminated). Additional features, such as the rear stop 67, the angled surface 98 of the rear end 96 of the panel guide assembly 88, and the vertical spacing between the upper support deck 58 and the lower support deck 60, may further contributed to the reduction (if not elimination) of product bridging.

Although various embodiments of the disclosed product dispensing system with increased container and dispenser openings have been shown and described, modifications may occur to those skilled in the art upon reading the specification. The present application includes such modifications and is limited only by the scope of the claims.

What is claimed is:

1. A product dispensing system comprising:
a dispenser frame having a front end longitudinally opposed from a rear end, said frame comprising:
an upper support deck extending between said front end and said rear end, said upper support deck defining a dispenser opening having a first longitudinal length; and
a lower support deck positioned below said upper support deck, said lower support deck defining a product display area;
a container positioned on said upper support deck, wherein said container defines a container opening having a second longitudinal length, said container opening being aligned with said dispenser opening; and
a plurality of products initially housed in said container, wherein each product of said plurality of products is configured to roll about a rolling axis and has a greatest transverse dimension perpendicular to said rolling axis,
wherein said first longitudinal length and said second longitudinal length are substantially greater than said greatest transverse dimension.

2. The product dispensing system of claim 1 wherein said first longitudinal length and said second longitudinal length are at least 1.5 times said greatest transverse dimension.

3. The product dispensing system of claim 1 wherein said first longitudinal length and said second longitudinal length are at least 1.7 times said greatest transverse dimension.

4. The product dispensing system of claim 1 wherein said first longitudinal length and said second longitudinal length are at least 1.9 times said greatest transverse dimension.

5. The product dispensing system of claim 1 wherein said first longitudinal length and said second longitudinal length are at least 2 times said greatest transverse dimension.

6. The product dispensing system of claim 1 wherein said first longitudinal length and said second longitudinal length are at least 2.2 times said greatest transverse dimension.

7. The product dispensing system of claim 1 wherein said first longitudinal length and said second longitudinal length are at least 2.5 times said greatest transverse dimension.

8. The product dispensing system of claim 1 wherein said first longitudinal length is sufficient to allow at least two products of said plurality of products to simultaneous pass through said dispenser opening.

9. The product dispensing system of claim 8 wherein said second longitudinal length is sufficient to allow at least two products of said plurality of products to simultaneous pass through said container opening.

10. The product dispensing system of claim 1 wherein at least one product of said plurality of products is positioned in said product display area.

11. The product dispensing system of claim 1 further comprising an opening tool connected to said frame.

12. The product dispensing system of claim 11 wherein said opening tool is configured to engage said container and form said container opening when said container is urged longitudinally along said upper support deck.

13. The product dispensing system of claim 11 further comprising a panel guide assembly connected to said upper support deck proximate said opening tool, wherein said panel guide assembly comprises an angled surface.

14. The product dispensing system of claim 1 wherein said product display area is positioned proximate said front end.

15. The product dispensing system of claim 1 wherein said lower support deck comprises a front end that extends toward said front end of said frame and a rear end that extends toward said rear end of said frame, and wherein an obstruction is positioned proximate said rear end of said lower support deck.

16. A product dispensing system comprising:
a dispenser frame having a front end longitudinally opposed from a rear end, said frame comprising:
an upper support deck extending between said front end and said rear end, said upper support deck defining a dispenser opening having a first longitudinal length; and
a lower support deck positioned below said upper support deck, said lower support deck defining a product display area proximate said front end;
a container positioned on said upper support deck, wherein said container defines a container opening having a second longitudinal length, said container opening being aligned with said dispenser opening; and
a plurality of products initially housed in said container, wherein each product of said plurality of products is configured to roll about a rolling axis and has a greatest diameter,
wherein said first longitudinal length and said second longitudinal length are at least 1.5 times said greatest diameter.

17. The product dispensing system of claim 16 wherein said first longitudinal length and said second longitudinal length are at least 2 times said greatest diameter.

18. The product dispensing system of claim 16 wherein said first longitudinal length and said second longitudinal length are at least 2.5 times said greatest diameter.

19. The product dispensing system of claim 16 wherein at least one product of said plurality of products is positioned in said product display area.

20. A product dispensing system comprising:
a dispenser frame having a front end longitudinally opposed from a rear end, said frame comprising:
an upper support deck extending between said front end and said rear end, said upper support deck defining a dispenser opening having a first longitudinal length; and
a lower support deck positioned below said upper support deck, said lower support deck defining a product display area proximate said front end;
a container positioned on said upper support deck, wherein said container defines a container opening having a second longitudinal length, said container opening being aligned with said dispenser opening; and
a plurality of products initially housed in said container, wherein each product of said plurality of products is configured to roll about a rolling axis and has a greatest diameter,
wherein said first longitudinal length is sufficient to allow at least two products of said plurality of products to simultaneous pass through said dispenser opening, and
wherein said second longitudinal length is sufficient to allow said two products to simultaneous pass through said container opening.
